(19) United States
(12) Patent Application Publication
(10) Pub. No.: US 2016/0335572 A1
(43) Pub. Date: Nov. 17, 2016

(54) MANAGEMENT OF COMMITMENTS AND REQUESTS EXTRACTED FROM COMMUNICATIONS AND CONTENT

(71) Applicant: Microsoft Technology Licensing, LLC, Redmond, WA (US)

(72) Inventors: Paul Nathan Bennett, Kirkland, WA (US); Nikrouz Ghotbi, Bellevue, WA (US); Eric Joel Horvitz, Kirkland, WA (US); Richard L. Hughes, Monroe, WA (US); Prabhdeep Singh, Newcastle, WA (US); Ryen William White, Woodinville, WA (US)

(21) Appl. No.: 14/714,109

(22) Filed: May 15, 2015

(51) Int. Cl. G06Q 10/06; G06Q 10/10

(52) U.S. Cl. CPC G06Q 10/06311; G06Q 10/1095

(57) ABSTRACT

A system that analyses content of electronic communications may automatically detect requests or commitments from the electronic communications. In one example process, a processor may identify a request or a commitment in the content of the electronic message; based, at least in part, on the request or the commitment, determine an informal contract; and execute one or more actions to manage the informal contract, the one or more actions based, at least in part, on the request or the commitment.

### BACKGROUND

Electronic communications have become an important form of social and business interactions. Such electronic communications include email, calendars, SMS text messages, voice mail, images, videos, and other digital communications and content, just to name a few examples. Electronic communications are generated automatically or manually by users on any of a number of computing devices.

### SUMMARY

This disclosure describes techniques and architectures for managing requests and commitments detected in electronic communications, such as messages between or among users. For example, an email exchange between two people may include text from a first person sending a request to a second person to perform a task, and the second person making a commitment to perform the task. A computing system may determine a number of task-oriented actions based, at least in part, on detecting a request and/or commitment. The computing system may automatically perform such actions by generating electronic signals to modify electronic calendars, display suggestions of possible user actions, and provide reminders to users, just to name a few examples.

This Summary is provided to introduce a selection of concepts in a simplified form that are further described below in the Detailed Description. This Summary is not intended to identify key or essential features of the claimed subject matter, nor is it intended to be used as an aid in determining the scope of the claimed subject matter. The term “techniques,” for instance, may refer to system(s), method(s), computer-readable instructions, module(s), algorithms, hardware logic (e.g., Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs)), and/or other technique(s) as permitted by the context above and throughout the document.

### BRIEF DESCRIPTION OF THE DRAWINGS

The detailed description is described with reference to the accompanying figures. In the figures, the left-most digit(s) of a reference number identifies the figure in which the reference number first appears. The same reference numbers in different figures indicate similar or identical items.

FIG. 1 is a block diagram depicting an example environment in which techniques described herein may be implemented.

FIG. 2 is a block diagram illustrating electronic communication subjected to an example task identification process.

FIG. 3 is a block diagram of multiple information sources that may communicate with an example task operations module.

FIG. 4 is a block diagram illustrating an electronic communication that includes an example text thread and a task identification process of a request and a commitment.

FIG. 5 is a table of example relations among messages, commitments and requests.

FIG. 6 is a flow diagram of an example task management process.

FIG. 7 is a block diagram of an example machine learning system.

FIG. 8 is a block diagram of example machine learning models.

FIG. 9 is a block diagram illustrating example processes for commitment and request extraction.

FIG. 10 is a flow diagram of an example task management process.

### DETAILED DESCRIPTION

Various examples describe techniques and architectures for a system that, among other things, manages tasks associated with requests and commitments detected or identified in electronic communications, such as messages between or among users. Among other examples, electronic communications may include text messages, comments in social media, and voice mail or voice streams listened into during calls by an agent. An email exchange between two people may include text from a first person sending a request to a second person to perform a task, and the second person making a commitment (e.g., agreeing) to perform the task. The email exchange may convey enough information for the system to automatically determine the presence of the request to perform the task and/or the commitment to perform the task. A computing system may perform a number of automatic actions based, at least in part, on the detected or identified request and/or commitment. Such actions may include modifying electronic calendars or to-do lists, providing suggestions of possible user actions, and providing reminders to users, just to name a few examples. The system may query a variety of sources of information that may be related to one or more portions of the email exchange. For example, the system may examine other messages exchanged by one or both of the authors of the email exchange or by other people. The system may also examine larger corpora of email and other messages. Beyond other messages, the system may query a calendar or database of one or both of the authors of the email exchange for additional information.

Generally, requests and resulting commitments may be viewed as notions of discussions associated with the proposal and acceptance of informal contracts to accomplish tasks (rather than formalized notions of contracts such as those written and signed in legal settings, for example). If commitments are not formalized (e.g., “formalized” by being fully and explicitly described and in a text or other form—“documented”), then such informal commitments may especially benefit from support or management, such as that automatically provided by a computing system. Management may include task reminders, scheduling, and resource allocation, just to name a few examples. In some implementations, task recognition and support may include by automatically tracking and managing ongoing commitments.

In some examples, an informal contract is a mutual agreement between two or more parties under which the parties agree (implicitly or explicitly) that some action should be (e.g., desirably) performed. An informal contract may involve requests to take action and corresponding commitments from others to do the requested action. Commitments to take action may also be made sans requests. While requests need not (yet) have an agreement (e.g., for a commitment), requests are an attempt to seek such an agreement. For example, a request or “ask” from an author of an email thread may not have a responsive commitment from another author of the email thread until a number of additional email exchanges occur.

Contracts are generally made in communications (written or spoken). An informal contract may or may not have legal implications. However, failure to respond to requests or to satisfy agreed-upon commitments may have social consequences on establishing and maintaining levels of trust and also have implications for successful coordination and collaboration. Support for informal contracts may often be focused on automation and assistance for only one of the parties or primary support to one of the parties versus symmetry often seen in legal contract settings.

In various examples, an informal contract (or the presence thereof) may be determined based, at least in part, on requests and/or commitments. For a particular example, a computing system may automatically extract information regarding tasks (e.g., requests and/or commitments) from a message. The computing system may use such extracted information to determine if an informal contract is present or set forth by the message. Such determining may be based, at least in part, on determining that a mutual agreement between or among parties associated with the message exists. In some implementations, the computing system may analyze one or more messages while performing such determining. If an informal contract is present, the computing system may further determine properties of the informal contract. In some examples, an informal contract comprises a task(s), identification of a person or persons (or machine) to perform the task(s), and enough details to sufficiently perform the task (e.g., such as times, locations, subjects, etc.). In particular, at some prior point in time, in some type of electronic communication, the person or persons (or machine) have made a commitment to perform the task.

In some examples, a mutual agreement may involve a conditional commitment. In particular, a “maybe” response to a request may not satisfy conditions of a mutual agreement. On the other hand, a conditional commitment may be a type of mutual agreement. For example, the following exchange may be considered to include a conditional agreement, and thus may be considered to be a mutual agreement: First person (request), “Can you stop by the grocery store on your way home?” Second person (conditional commitment), “If you send me a short grocery list before 4 p.m., I can do it.” In such a case, the conditional commitment may lead to a commitment (and mutual agreement) if the first person sends a grocery list to the second person before 4 pm to fulfill the condition. Conditional commitments generally occur relatively frequently and a computing system that automatically tracks conditional commitments with or without a “final” message that fulfills the condition may be beneficial.

As described herein, “task content” refers to an informal contract or one or more requests and/or one or more commitments that are conveyed in the meaning of a communication, such as a message. Unless otherwise explicitly noted or implied by the context of a particular sentence, “identifying” or “detecting” task content in a message or communication refers to recognizing the presence of task content and determining at least partial meaning of the task content. For example, “identifying a request in an email” means recognizing the presence of a request in the email and determining the meaning of the request. “Meaning” of a request may include information regarding the sender and the receiver of the request (e.g., who is making the request, and to whom are they making the request), time aspects (e.g., when was the request generated, by what time/day is the action(s) of the request to be performed), what is the subject of the request (e.g., what actions are to be performed to satisfy the request), the relationship between the sender and the receiver (e.g., is the sender the receiver's boss), and so on. Meaning of a commitment may include information regarding the sender and the receiver of the commitment (e.g., who is making the commitment, and to whom are they making the commitment), time aspects (e.g., when was the commitment generated, by what time/day is the action(s) of the commitment to be performed), what is the subject of the commitment (e.g., what actions are to be performed to satisfy the commitment), and so on. A request may generate a commitment, but a commitment may be made without a corresponding request. Moreover, a commitment may generate a request. For example, the commitment “I'll correct the April report” may result in a request such as “Great—can you also revise the May report as well?”

Once identified by a computing system, an informal contract or task content (e.g., the proposal or affirmation of a commitment or request) of a communication may be further processed or analyzed to identify or infer semantics of the commitment or request including: identifying the primary owners of the request or commitment (e.g., if not the parties in the communication); the nature of the task content and its properties (e.g., its description or summarization); specified or inferred pertinent dates (e.g., deadlines for completing the commitment); relevant responses such as initial replies or follow-up messages and their expected timing (e.g., per expectations of courtesy or around efficient communications for task completion among people or per an organization); and information resources to be used to satisfy the request. Such information resources, for example, may provide information about time, people, locations, and so on. The identified task content and inferences about the task content may be used to drive automatic (e.g., computer generated) services such as reminders, revisions (e.g., and displays) of to-do lists, appointments, meeting requests, and other time management activities. In some examples, such automatic services may be applied during the composition of a message (e.g., typing an email or text), reading the message, or at other times, such as during offline processing of email on a server or client device. The initial extraction and inferences about a request or commitment may also invoke services that work with one or more participants to confirm or refine current understandings or inferences about the request or commitment and the status of the request or commitment based, at least in part, on the identification of missing information or of uncertainties about one or more properties detected or inferred from the communication. Other properties of the commitment or request may include the estimated duration involved in the commitment, the action that should be taken (e.g., booking time, setting a reminder, scheduling a meeting, and so on), and a broader project to which the commitment and/or request are associated that may be inferred from the text of the C&Rs and associated metadata.

In some examples, task content may be detected in multiple forms of communications, including digital content capturing interpersonal communications (e.g., email, SMS text, instant messaging, posts in social media, and so on) and composed content (e.g., email, note-taking and organizational tools such as OneNote® by Microsoft Corporation of Redmond, Wash., word-processing documents, and so on).

Some example techniques for identifying task content from various forms of electronic communications may involve language analysis of content of the electronic communications, which human annotators may annotate as containing commitments or requests. Human annotations may be used in a process of generating a corpus of training data that is used to build and to test automated extraction of commitments or requests and various properties about the commitments or requests.

Techniques may also involve proxies for human-generated labels (e.g., based on email engagement data, such as email response rate or time-to-response, or relatively sophisticated extraction methods). For developing methods used in extraction systems or for real-time usage of methods for identifying and/or inferring requests or commitments and their properties, analyses may include natural language processing (NLP) analyses at different points along a spectrum of sophistication. For example, an analysis having a relatively low-level of sophistication may involve identifying key words based on word breaking and stemming. An analysis having a relatively mid-level of sophistication may involve consideration of larger analyses of sets of words (“bag of words”). An analysis having a relatively high-level of sophistication may involve sophisticated parsing of sentences in communications into parse trees and logical forms. Techniques for identifying task content may involve featurizing (e.g., identifying attributes or features of) components of messages and sentences of the messages. For example, a process of featurizing a communication may identify features of text fragments that are capable of being classified. Such techniques may employ such features in a training and testing paradigm to build a statistical model to classify components of the message. For example, such components may comprise sentences or the overall message as containing a request and/or commitment.

In some examples, techniques for task content detection may involve a hierarchy of analysis, including using a sentence-centric approach, consideration of multiple sentences in a message, and global analyses of relatively long communication threads. In some examples, such relatively long communication threads may include sets of messages over a period of time, and sets of threads and longer-term communications (e.g., spanning days, weeks, months, or years). Multiple sources of content associated with particular communications may be considered. Such sources may include histories and/or relationships of/among people associated with the particular communications, locations of the people during a period of time, calendar information of the people, and multiple aspects of organizations and details of organizational structure associated with the people.

In some examples, techniques may directly consider requests or commitments identified from components of content as representative of the requests or commitments, or may be further summarized. Techniques may determine other information from a sentence or larger message, including relevant dates (e.g., deadlines on which requests or commitments are due), locations, urgency, time-requirements, task subject matter, and people. Beyond text of a message, techniques may consider other information for detection and summarization, such as images and other graphical content, the structure of the message, the subject header, and information on the sender and recipients of the message. Techniques may also consider features of the message itself (e.g., the number of recipients, number of replies, overall length, and so on) and the context (e.g., day of week). In some examples, a technique may further refine or prioritize initial analyses of candidate messages/content or resulting task content determinations based, at least in part, on the sender or recipient(s) and histories of communication and/or of the structure of the organization.

In some examples, a computing system may construct predictive models for identifying or managing requests and commitments and related information using machine learning procedures that operate on training sets of annotated corpora of sentences or messages. Such annotations may be derived from the fielding of a task (e.g., commitment/request) processing system and the observed user behavior with respect to tasks. For example, observed user behavior may include users setting up meetings for a particular task versus users setting up reminders for the same particular task. Such observed user behavior may be used as training data for managing tasks. In other examples, a computing system may use relatively simple rule-based approaches to perform task content determinations and summarization.

In some examples, a computing system may explicitly notate task content detected in a message in the message itself. In various examples, a computing system may flag messages containing requests and commitments in multiple electronic services and experiences, which may include products or services such as Windows®, Cortana®, Outlook®, Outlook Web App® (OWA), Xbox®, Skype®, Lync®, and Band®, all by Microsoft Corporation, and other such services and experiences from others. In various examples, a computing system may detect or identify requests and commitments from audio feeds, such as from voicemail messages, SMS images, instant messaging streams, and verbal requests to digital personal assistants, just to name a few examples.

In some examples, a computing system may learn to improve predictive models and summarization used for detecting and managing task content by implicit and explicit feedback by users, as described below.

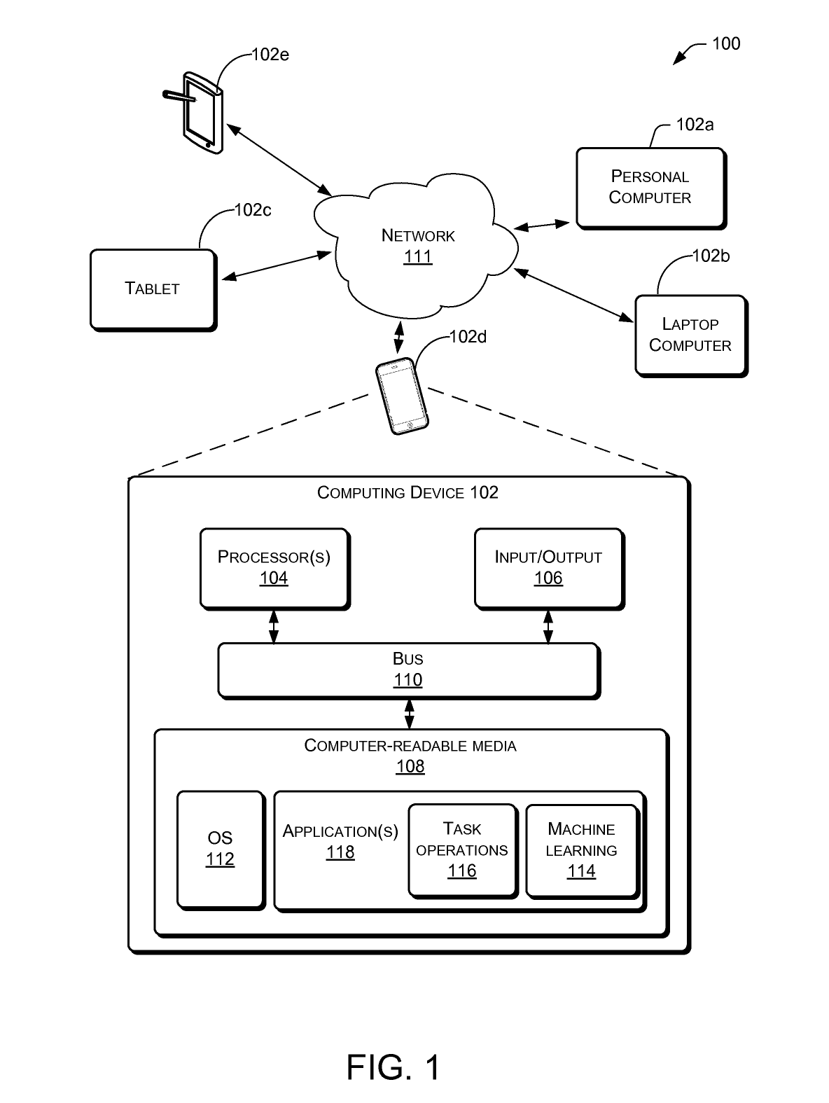

Various examples are described further with reference to FIGS. 1-10.

The environment described below constitutes but one example and is not intended to limit the claims to any one particular operating environment. Other environments may be used without departing from the spirit and scope of the claimed subject matter.

FIG. 1 illustrates an example environment 100 in which example processes involving determination or identification of task content (e.g., task content determination) as described herein can operate. In some examples, the various devices and/or components of environment 100 include a variety of computing devices 102. By way of example and not limitation, computing devices 102 may include devices 102a-102e. Although illustrated as a diverse variety of device types, computing devices 102 can be other device types and are not limited to the illustrated device types. Computing devices 102 can comprise any type of device with one or multiple processors 104 operably connected to an input/output interface 106 and computer-readable media 108, e.g., via a bus 110. Computing devices 102 can include personal computers such as, for example, desktop computers 102a, laptop computers 102b, tablet computers 102c, telecommunication devices 102d, personal digital assistants (PDAs) 102e, electronic book readers, wearable computers (e.g., smart watches, personal health tracking accessories, augmented reality and virtual reality devices, etc.), automotive computers, gaming devices, etc. Computing devices 102 can also include, for example, server computers, thin clients, terminals, and/or work stations. In some examples, computing devices 102 can include components for integration in a computing device, appliances, or other sorts of devices.

In some examples, some or all of the functionality described as being performed by computing devices 102 may be implemented by one or more remote peer computing devices, a remote server or servers, or distributed computing resources, e.g., via cloud computing. In some examples, a computing device 102 may comprise an input port to receive electronic communications. Computing device 102 may further comprise one or multiple processors 104 to access various sources of information related to or associated with particular electronic communications. Such sources may include electronic calendars and databases of histories or personal information about authors of messages included in the electronic communications, just to name a few examples. In some examples, an author has to “opt-in” or take other affirmative action before any of the multiple processors 104 can (e.g., by executing code) access personal information of the author. In some examples, one or multiple processors 104 may be configured to detect and manage task content included in electronic communications. One or multiple processors 104 may be hardware processors or software processors. As used herein, a processing unit designates a hardware processor.

In some examples, as shown regarding device 102d, computer-readable media 108 can store instructions executable by the processor(s) 104 including an operating system (OS) 112, a machine learning module 114, a task operations module 116 and programs or applications 118 that are loadable and executable by processor(s) 104. The one or more processors 104 may include one or more central processing units (CPUs), graphics processing units (GPUs), video buffer processors, and so on. In some examples, machine learning module 114 comprises executable code stored in computer-readable media 108 and is executable by processor(s) 104 to collect information, locally or remotely by computing device 102, via input/output 106. The information may be associated with one or more of applications 118. Machine learning module 114 may selectively apply any of a number of machine learning decision models stored in computer-readable media 108 (or, more particularly, stored in machine learning module 114) to apply to input data.

In some examples, task operations module 116 comprises executable code stored in computer-readable media 108 and is executable by processor(s) 104 to collect information, locally or remotely by computing device 102, via input/output 106. The information may be associated with one or more of applications 118. Task operations module 116 may selectively apply any of a number of statistical models or predictive models (e.g., via machine learning module 114) stored in computer-readable media 108 to apply to input data to identify or manage task content. In some examples, however, managing task content need not use a “model”. For example, simple heuristical or rule-based systems may instead (or also) be applied to manage task content.

Though certain modules have been described as performing various operations, the modules are merely examples and the same or similar functionality may be performed by a greater or lesser number of modules. Moreover, the functions performed by the modules depicted need not necessarily be performed locally by a single device. Rather, some operations could be performed by a remote device (e.g., peer, server, cloud, etc.).

Alternatively, or in addition, some or all of the functionality described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

In some examples, computing device 102 can be associated with a camera capable of capturing images and/or video and/or a microphone capable of capturing audio. For example, input/output module 106 can incorporate such a camera and/or microphone. Images of objects or of text, for example, may be converted to text that corresponds to the content and/or meaning of the images and analyzed for task content. Audio of speech may be converted to text and analyzed for task content.

Computer readable media 108 includes computer storage media and/or communication media. Computer storage media includes volatile and non-volatile, removable and non-removable media implemented in any method or technology for storage of information such as computer readable instructions, data structures, program modules, or other data. Computer storage media includes, but is not limited to, phase change memory (PRAM), static random-access memory (SRAM), dynamic random-access memory (DRAM), other types of random-access memory (RAM), read-only memory (ROM), electrically erasable programmable read-only memory (EEPROM), flash memory or other memory technology, compact disk read-only memory (CD-ROM), digital versatile disks (DVD) or other optical storage, magnetic cassettes, magnetic tape, magnetic disk storage or other magnetic storage devices, or any other non-transmission medium that can be used to store information for access by a computing device.

In contrast, communication media embodies computer readable instructions, data structures, program modules, or other data in a modulated data signal, such as a carrier wave, or other transmission mechanism. As defined herein, computer storage media does not include communication media. In various examples, computer-readable media 108 is an example of computer storage media storing computer-executable instructions. When executed by processor(s) 104, the computer-executable instructions configure the processor(s) to, among other things, analyze content of an individual electronic message, where the electronic message is (i) received among the electronic communications, (ii) entered by a user via a user interface, or (iii) retrieved from memory; and based, at least in part, on the analyzing the content, identify, from the electronic message, text corresponding to a request or to a commitment.

In various examples, an input device of or connected to input/output (I/O) interfaces 106 may be a direct-touch input device (e.g., a touch screen), an indirect-touch device (e.g., a touch pad), an indirect input device (e.g., a mouse, keyboard, a camera or camera array, etc.), or another type of non-tactile device, such as an audio input device.

Computing device(s) 102 may also include one or more input/output (I/O) interfaces 106, which may comprise one or more communications interfaces to enable wired or wireless communications between computing device 102 and other networked computing devices involved in extracting task content, or other computing devices, over network 111. Such communications interfaces may include one or more transceiver devices, e.g., network interface controllers (NICs) such as Ethernet NICs or other types of transceiver devices, to send and receive communications over a network. Processor 104 (e.g., a processing unit) may exchange data through the respective communications interfaces. In some examples, a communications interface may be a PCIe transceiver, and network 111 may be a PCIe bus. In some examples, the communications interface may include, but is not limited to, a transceiver for cellular (3G, 4G, or other), WI-FI, Ultra-wideband (UWB), BLUETOOTH, or satellite transmissions. The communications interface may include a wired I/O interface, such as an Ethernet interface, a serial interface, a Universal Serial Bus (USB) interface, an INFINIBAND interface, or other wired interfaces. For simplicity, these and other components are omitted from the illustrated computing device 102. Input/output (I/O) interfaces 106 may allow a device 102 to communicate with other devices such as user input peripheral devices (e.g., a keyboard, a mouse, a pen, a game controller, a voice input device, a touch input device, gestural input device, and the like) and/or output peripheral devices (e.g., a display, a printer, audio speakers, a haptic output, and the like).

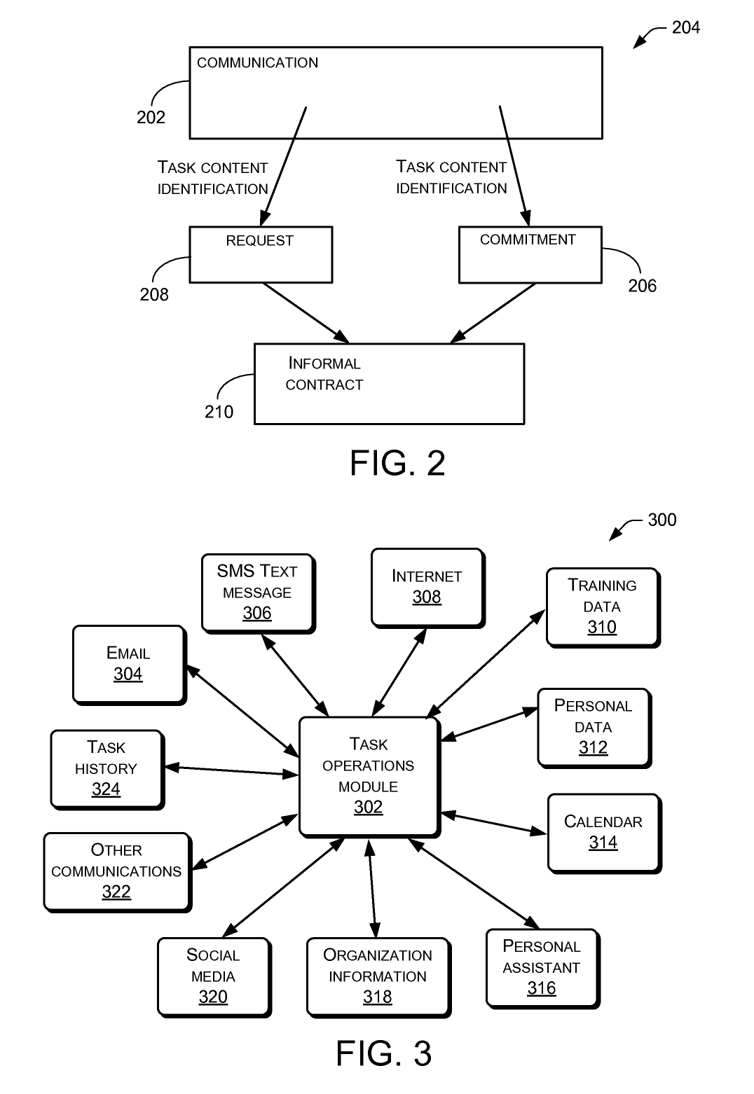

FIG. 2 is a block diagram illustrating electronic communication 202 subjected to an example task content identification process 204. For example, process 204 may involve any of a number of techniques for detecting whether a commitment 206 or request 208 has been made (e.g., is included) in incoming or outgoing communications. Process 204 may also involve techniques for automatically marking, annotating, or otherwise identifying the message as containing a commitment or request. In some examples, process 204 may include techniques that generate a summary (not illustrated) of commitments or requests for presentation and follow-up tracking and analysis. Commitments 206 or requests 208 may be identified in multiple forms of content of electronic communication 202. Such content may include interpersonal communications such as email, SMS text or images, instant messaging, posts in social media, meeting notes, and so on. Such content may also include content composed using email applications or word-processing applications, among other possibilities.

In a number of examples, process 204 may use extracted commitments 206 and requests 208 to determine if an informal contract 210 is present or set forth by communication 202. Such determining may be based, at least in part, on determining that a mutual agreement between or among parties associated with the communication exists. In some implementations, a computing system performing process 204 may analyze one or more other communications while performing such determining. If informal agreement 210 is present, the computing system may further determine properties of the informal contract. Such properties may include details of the requests and commitments (times, locations, subjects, persons and/or things involved, etc.).

FIG. 3 is a block diagram of an example system 300 that includes a task operations module 302 in communication with a number of entities 304-324. Such entities may include host applications (e.g., Internet browsers, SMS text editors, email applications, electronic calendar functions, and so on), databases or information sources (e.g., personal data and histories of individuals, organizational information of businesses or agencies, third party data aggregators that might provide data as a service, and so on), just to name a few examples. Task operations module 302 may be the same as or similar to task operations module 116 in computing device 102, illustrated in FIG. 1, for example.

Task operations module 302 may be configured to analyze content of communications, and/or data or information provided by entities 304-324 by applying any of a number of language analysis techniques (though simple heuristical or rule-based systems may also be employed).

For example, task operations module 302 may be configured to analyze content of communications provided by email entity 304, SMS text message entity 306, and so on. Task operations module 302 may also be configured to analyze data or information provided by Internet entity 308, a machine learning entity providing training data 310, email entity 304, calendar entity 314, and so on. Task operations module 302 may analyze content by applying language analysis to information or data collected from any of entities 304-324. In some examples, task operations module 302 may be configured to analyze data regarding historic task interactions from task history entity 324, which may be a memory device. For example, such historic task interactions may include actions that people performed for previous commitments and/or requests. Information about such actions (e.g., what people did in response to a particular type of commitment, and so on) may indicate what actions people may perform for similar tasks. Accordingly, historic task interactions may be considered in decisions about current or future task operations.

Double-ended arrows in FIG. 3 indicate that data or information may flow in either or both directions among entities 304-324 and task operations module 302. For example, data or information flowing from task operations module 302 to any of entities 304-324 may result from task operations module 302 providing extracted task data to entities 304-324. In another example, data or information flowing from task operations module 302 to any of entities 304-324 may be part of a query generated by the task operations module to query the entities. Such a query may be used by task operations module 302 to determine one or more meanings of content provided by any of the entities, and determine and establish task-oriented processes based, at least in part, on the meanings of the content, as described below.

In some examples, task operations module 302 may receive content of an email exchange (e.g., a communication) among a number of users from email entity 304. The task operations module may analyze the content to determine one or more meanings of the content. Analyzing content may be performed by any of a number of techniques to determine meanings of elements of the content, such as words, phrases, sentences, metadata (e.g., size of emails, date created, and so on), images, and how and if such elements are interrelated, for example. “Meaning” of content may be how one would interpret the content in a natural language. For example, the meaning of content may include a request for a person to perform a task. In another example, the meaning of content may include a description of the task, a time by when the task should be completed, background information about the task, and so on. In another example, the meaning of content may include properties of desired action(s) or task(s) that may be extracted or inferred based, at least in part, on a learned model. For example, properties of a task may be how much time to set aside for such a task, should other people be involved, is this task high priority, and so on.

In an optional implementation, the task operations module may query content of one or more data sources, such as social media entity 320, for example. Such content of the one or more data sources may be related (e.g., related by subject, authors, dates, times, locations, and so on) to the content of the email exchange. Based, at least in part, on (i) the one or more meanings of the content of the email exchange and (ii) the content of the one or more data sources, task operations module 302 may automatically establish one or more task-oriented processes based, at least in part, on a request or commitment from the content of the email exchange.

In some examples, task operations module 302 may establish one or more task-oriented processes based, at least in part, on task content using predictive models learned from training data 310 and/or from real-time ongoing communications among the task operations module and any of entities 304-324. Predictive models may be combined with formal contract-based methods for handling tasks (e.g., systems that enable users to move from inferred to formal logical/contract-based approaches to managing commitments and requests). Predictive models may infer that an outgoing or incoming communication (e.g., message) or contents of the communication contain a request. Similarly, an outgoing or incoming communication or contents of the communication may contain commitments (e.g., a pledge or promise) to perform tasks. The identification of commitments and requests from incoming or outgoing communications may serve multiple functions that support the senders and receivers of the communications about commitments and requests. Such functions may be to generate and provide reminders to users, revisions of to-do lists, appointments, meeting requests, and other time management activities. Such functions may also include finding or locating related digital artefacts (e.g., documents) that support completion of, or user comprehension of, a task activity.

In some examples, task operations module 302 may establish one or more task-oriented processes based, at least in part, on task content using statistical models to identify the proposing and affirming of commitments and requests from email received from email entity 304 or SMS text messages from SMS text message entity 306, just to name a few examples. Statistical models may be based, at least in part, on data or information from any or a combination of entities 304-324.

In some examples, task operations module 302 may establish one or more task-oriented processes based, at least in part, on task content while the author of a message writes the message. For example, such writing may comprise typing an email or text message using any type of text editor or application. In other examples, task operations module 302 may establish one or more task-oriented processes based, at least in part, on task content while a person reads a received message. For example, as the person reads a message, task operations module 302 may annotate portions of the message by highlighting or emphasizing requests or commitments in the text of the message. In some examples, the task operations module may add relevant information to the message during the display of the message. For example, such relevant information may be inferred from additional sources of data or information, such as from entities 304-324. In a particular example, a computer system that includes task operations module 302 may display a message that includes a request for the reader to attend a type of class. Task operations module 302 may query Internet 308 to determine that a number of such classes are offered in various locations and at various times of day in an area where the reader resides (e.g., which may be inferred from personal data 312 regarding the reader). Accordingly, the task operations module may generate and provide a list of choices or suggestions to the reader. Such a list may be dynamically displayed near text of pertinent portions of the text in response to mouse-over, or may be statically displayed in other portions of the display, for example. In some examples, the list may include items that are selectable (e.g., by a mouse click) by the reader so that the request will include a time selected by the reader (this time may replace a time “suggested” by the requester and the requester may be automatically notified of the time selected by the reader).

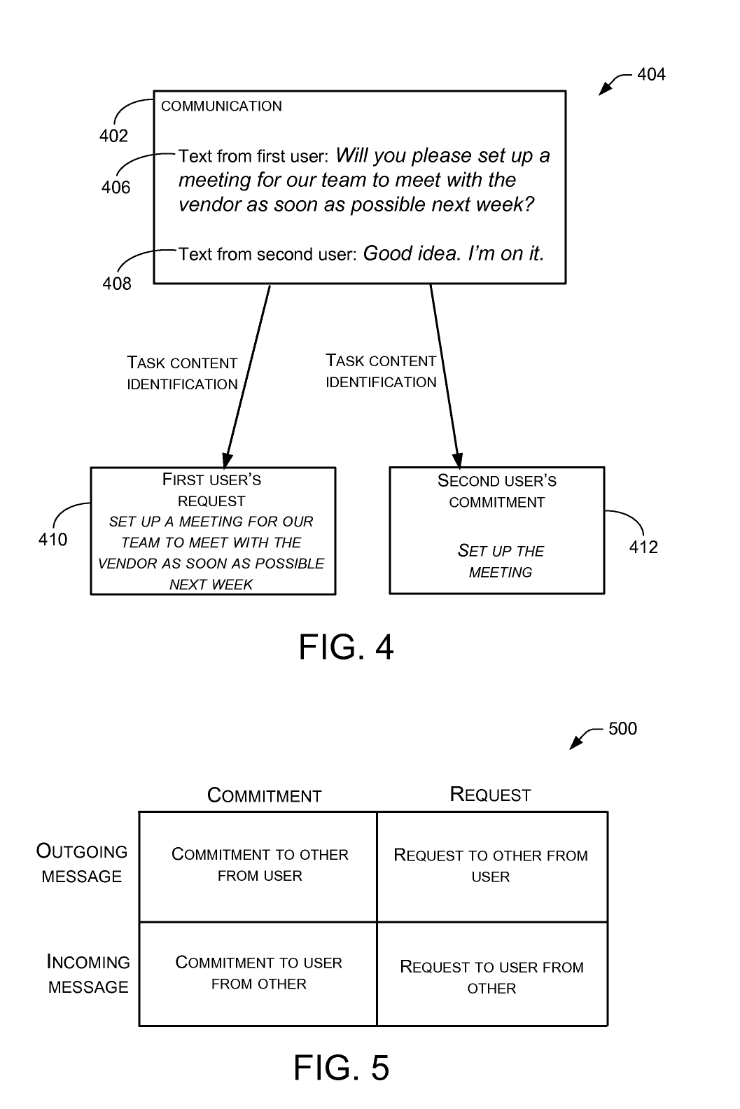

FIG. 4 is a block diagram illustrating an electronic communication 402 that includes an example text thread and a task identification process 404 of a request or a commitment. Such a process, for example, may be performed by a task operations module, such as 116, illustrated in FIG. 1. For example, communication 402, which may be a text message to a second user received on a computing device of the second user from a first user, includes text 406 from the first user and text 408 from the second user. Task identification process 404 includes analyzing content (e.g., text 406 and text 408) of communication 402 and determining (i) a commitment by the first user or the second user and/or (ii) a request by the first user or the second user.

In the example illustrated in FIG. 4, text 406 by the first user includes a request 410 that the second user set up a meeting for our team to meet with the vendor as soon as possible next week. Text 408 by the second user includes a commitment 412 that the second user intends to set up such a meeting by the implication good idea. I'm on it. Task identification process 404 may determine the request and commitment by any of a number of techniques involving analyzing text 406 and text 408. In some examples, if the text is insufficient for determining sufficient details of a request or commitment, then task identification process 404 may query any of a number of data sources, such as entities 304-324. For example, the request of text 406 did not include a particular time for when to set up a meeting or when to have such a meeting occur, except that the meeting should occur as soon as possible next week. Also, information regarding who should attend the meeting is limited to “our team”. Accordingly, task identification process 404 may query information in any of a number of data sources (e.g., Internet 308, personal data 312, calendar, 314, personal assistant 316, social media 320, and so on) about the first user and/or the second user. Information about the first and/or the second user may include personal data, work data, schedules, calendars, information about the workplace (e.g., from organization information 318, which may provide information about fellow employees and descriptions of their jobs, titles, etc.), and so on to identify “our team” among other aspects. Follow-on information that may be queried includes meeting room details (e.g., one or more parameters of the meeting that may be gleaned from organization information 318 or calendar 314, which may provide information about schedules, sizes, locations, etc. of meeting rooms) of the work place of the first and second user.

Subsequent to querying such information, task identification process 404 may determine a substantially complete assessment of the request and the commitment in communication 402 and may generate and perform a number of task-oriented processes based on such an assessment. For example, task identification process 404 may provide to the second user a number of possible meeting times and places available for a meeting next week. The task identification process may provide to the second user a list of names of “our team” and schedules of individuals of the team. The task identification process may allow the second user to confirm or refute whether each individual is on the team and/or should attend the meeting. The task identification process may suggest possible times or days for the meeting based on schedules of the individuals, and consider the “importance” of the individuals (e.g., presence of some team members may be required or optional).

In some examples, task identification process 404 may determine a strength of a commitment, where a low-strength commitment is one for which the user is not likely to fulfill the commitment and a high-strength commitment is one for which the user is highly likely to fulfill the commitment. Strength of a commitment may be useful for subsequent services such as reminders, revisions of to-do lists, appointments, meeting requests, and other time management activities. Determining strength of a commitment may be based, at least in part, on history of events of the user (e.g., follow-through of past commitments, and so on) and/or history of events of the other user and/or personal information (e.g., age, sex, age, occupation, frequent traveler, and so on) of the first user, the second user, or another user. For example, task identification process 404 may query such histories. In some examples, either or all of the users have to “opt-in” or take other affirmative action before task identification process 404 may query personal information of the users. Task identification process 404 may assign a relatively high strength for a commitment by the second user if such histories demonstrate that the second user, for example, has set up a relatively large number of meetings in the past year or so. Determining strength of a commitment may also be based, at least in part, on key words or terms in text 406 and/or text 408. For example, “Good idea. I'm on it.” generally has positive and desirable implications, so that such a commitment may be relatively strong. On the other hand, “I'm on it” is relatively vague and falls short of a strongly worded commitment (e.g., such as “I'll do it”). In some implementations, task identification process 404 may determine a strength of a commitment based, at least in part, on particular words used in a message. For example, a hierarchy of words and/or phrases used in the message may correspond to a level of commitment. In a particular example, words such as “maybe”, “if”, “but”, “although”, and so on may indicate a conditional commitment. Accordingly, information about the second user and/or history of actions of the second user may be used by task identification process 404 to determine strength of this commitment. Task identification process 404 may weigh a number of such scenarios and factors to determine the strength of a commitment.

FIG. 5 is a table 500 of example relations among messages and task content. In particular, such task content includes commitments and/or requests, either of which may be generated (e.g., automatically by an application or manually written) by a user of a computing device or “other user entity”, which may be one or more people on one or more computing devices. In some examples, the other user entity may be the user, who may send a message to him or herself. In other examples, the user and/or the other user entity may be any person (e.g., a delegate, an assistant, a supervisor, etc.) or a machine (e.g., a processor-based system configured to receive and perform instructions). Table 500 illustrates outgoing messages that are generated by the user of the computing device and transmitted to the other user entity, and incoming messages that are generated by the other user entity and received by the user of the computing device.

Examples of commitments that may be detected in outgoing or incoming messages include: “I will prepare the documents and send them to you on Monday.” “I will send Mr. Smith the check by end of day Friday.” “I'll do it.” “I'll get back to you.” “Will do.” And so on. The latter examples demonstrate that a commitment (or statement thereof) need not include a time or deadline. Examples of requests that may be extracted from incoming or outgoing messages include: “Can you make sure to leave the key under the mat?” “Let me know if you can make it earlier for dinner.” “Can you get the budget analysis done by end of month?” And so on.

In response to commitments or requests being detected in outgoing or incoming messages, a processor executing module(s) may configure one or more computing devices to perform services such as reminders, revision of to-do lists, appointments, and time management of activities related to the commitments or requests. Such a processor executing module(s) may perform operations similar to that of task operations module 302, for example. Additionally, a processor executing module(s) may assist users in keeping track of outgoing requests and incoming commitments. For example, the processor may present a user with a list of actions on which to follow-up or automatically remind other users of requests sent to them by the user or commitments made to the user.

Table 500 includes four particular cases of tasks included in messages. One case is an outgoing message that includes a commitment to the other user entity by the user. Another case is an outgoing message that includes a request to the other user entity by the user. Yet another case is an incoming message that includes a commitment to the user from the other user entity. Still another case is an incoming message that includes a request from the other user entity to the user. Processes for detecting task content from the messages may differ from one another depending, at least in part, on which of the particular cases is being processed. Such processes may be performed by the computing device of the user or a computing system (e.g., server) in communication with the computing device. For example, a process applied to the case where an incoming message includes a commitment to the user from the other user entity may involve querying various data sources to determine any of a number of details (e.g., in addition to details provided by the other user entity) related to the commitment. Such various data sources may include personal data or history of the other user entity, schedule of related events (e.g., calendar data), search engine data responsive to key word searches based, at least in part, on words associated with the commitment, and so on. In some implementations, data sources may be memory associated with a processing component of a device, such as a memory device electronically coupled to a processor via a bus. A commitment directed to repairing a refrigerator, for example, (e.g., “yes, I'd be happy to get your refrigerator fixed while you are out of town.”) may lead to key words “refrigerator”, “appliance”, “repair”, “home repair”, and so on to be applied to an Internet search. Results of such a search (and/or the key words themselves) may be automatically provided to the other user entity subsequent to when the other user entity makes the commitment or while the other user entity is reading the request (and deciding whether or not to make the commitment, for example). Moreover, personal data regarding the user may be queried to determine the period for when the user will be “out of town”. Such queried information may, for example, allow the process to determine a time by when the commitment should be fulfilled. In some examples, the user and/or the other user entity has to “opt-in” or take other affirmative action before processes can access personal information of the user and/or the other user entity.

As another example, a process applied to the case where an outgoing message includes a request to the other user entity by the user may involve querying various data sources (which need not be external to the device(s) performing the process) to determine likelihood of outcome of the other user entity responding with a strong (e.g., sincere, reliable, worthy) commitment to the request of the user. Such determined likelihood may be useful for the user to determine whether to continue to send the request to the other user entity or to choose another user entity (who may be more likely to fulfill a commitment for the particular request). Various data sources may include personal data or history of the other user entity. For example, history of actions (cancelling meetings or failing to follow-through with tasks) by the other user entity may be indicative of the likelihood (or lack thereof) that the other user entity will accept or follow-through with a commitment to the request of the user.

On the other hand, a process applied to the case where an incoming message includes a request from the other user entity to the user may involve querying various data sources to determine logistics and various details about performing a potential commitment for the request. For example, a request in an incoming message may be “Can you paint the outside of my house next week?” Such a request may lead to a query directed to, among a number of other things, weather forecast providers (e.g., via the Internet). If the weather next week is predicted to be rainy, then the process may automatically (e.g., without any prompting by the user) provide the user with such weather information. In some examples, the process may provide the user with a score or some quantifier to assist the user in deciding whether or not to commit to the request. For example, a score of 10 indicates a relatively easy task associated with the commitment to the request. A score of 1 indicates an impossible task associated with the commitment to the request. Such impossibility may be due to schedule conflicts, particular people or equipment not available, weather, and so on.

In another example, a process applied to the case where an outgoing message includes a commitment to the other user entity by the user may involve querying various data sources to determine importance of the commitment. For example, if the other user entity is a supervisor of the user then the commitment is likely to be relatively important. Accordingly, the process may query various data sources that include personal and/or professional data of the other user entity to determine if the other user entity is a supervisor, subordinate, co-worker, friend, family, and so on. For example, if the other user entity is a supervisor, then the process may prioritize scheduling associated with the commitment to the supervisor, such as by automatically cancelling any calendar events that may interfere with performing the task(s) of the commitment (e.g., a lunch meeting with a friend at 12:30 pm may be automatically cancelled in the user's calendar to clear time for a commitment of a one-hour meeting at noon requested by the supervisor). Accordingly, a process performed by a task operations module may automatically modify an attendee list for a meeting based, at least in part, on information received from one or more data sources (e.g., personal data of authors of a message). In other examples, in lieu of such automation, a process may perform a task subsequent to explicit confirmation by a user. Moreover, a process may modify an electronic calendar of one or more authors of the content of a message, where the modifying is based, at least in part, on relative relationships (e.g., supervisor, subordinate, peer, and so on) between or among one or more authors of the message.

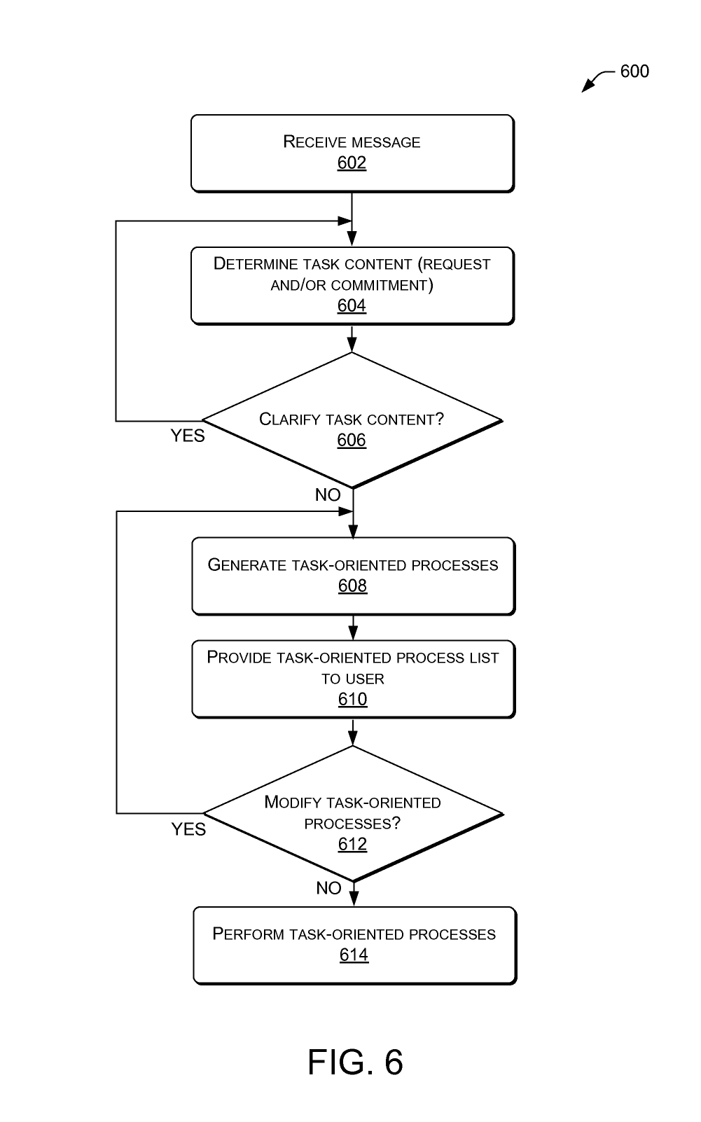

FIG. 6 is a flow diagram of a process 600 for performing task-oriented processes based, at least in part, on a task content (e.g., a request or a commitment) included in a message. For example, task operations module 302, illustrated in FIG. 3, may perform process 600. At block 602, task operations module 302 may receive a message, such as an email, text message, or any other type of communication between or among people or machines (e.g., computer systems capable of generating messages). At block 604, task operations module 302 may determine task content included in the message. As discussed above, any of a number of techniques may be used to make such a determination. Difficulty and complexity of determining task content in generally varies for different messages. For relatively simple situations, task operations module 302 may determine task content with relatively high confidence. In relatively complicated situations, task operations module 302 may determine task content with relatively low confidence. In both cases, and particularly the latter case, task operations module 302 may prompt a user to confirm whether determined task content is correct or accurate. Accordingly, at diamond 606, task operations module 302 may prompt the user for confirmation or to provide corrections or refinement to the determined task content. For example, an email to a user may be “Can you get the budget analysis done by the end of the month?” The user may be asked by task operations module 302 (e.g., in a displayed message or an audio message) if a determined request in the email is “finish the budget analysis by end April.” The user may confirm that this is true. In such a case, process 600 may proceed to block 608.

On the other hand, the user may respond by making a correction or by responding that the determined request is false. For example, the correct month may be May or June. In some examples, task operations module 302, during such a confirmation process, may provide the user with a list of options (e.g., April, May, June, July . . . ) based on likely possibilities. The user may select an option in the list. Process 600 may return to block 604 to modify or to determine task content in view of the user's response.

At block 608, task operations module 302 may generate one or more task-oriented actions based, at least in part, on the determined task content. Such actions may include modifying electronic calendars or to-do lists, providing suggestions of possible user actions, and providing reminders to users, just to name a few examples. In some examples, task operations module 302 may generate or determine task-oriented processes by making inferences about nature and timing of “ideal” actions, based on determined task content (e.g., estimates of a user-desired duration). In some examples, task operations module 302 may generate or determine task-oriented processes by automatically identifying and promoting different action types based on the nature of a determined request or commitment (e.g., “write report by 5 pm” may require booking time, whereas “let me know by 5 pm” suggests the need for a reminder).

At block 610, task operations module 302 may provide a list of the task-oriented actions to the user for inspection or review. For example, a task-oriented action may be to find or locate digital artefacts (e.g., documents) related to a particular task to support completion of, or user comprehension of, a task activity. At diamond 612, the user may select among choices of different possible actions to be performed by task operations module 302, may refine possible actions, may delete actions, may manually add actions, and so on. If there are any such changes, then process 600 may return to block 608 where task operations module 302 may re-generate task-oriented process in view of the user's edits of the task-oriented process list. On the other hand, if the user approves the list, then process 600 may proceed to block 614 where task operations module 302 performs the task-oriented processes.

In some examples, task-oriented processes may involve: generating ranked lists of actions available for determined requests or commitments; task-related inferring, extracting, and using inferred dates, locations, intentions, and appropriate next-steps; providing key data fields for display that are relatively easy to modify; tracking life histories of requests and commitments with multistep analyses, including grouping requests or commitments into higher-order tasks or projects to provide support for people to achieve such tasks or projects; iteratively modifying a schedule for one or more authors of an electronic message over a period of time (e.g., initially establishing a schedule and modifying the schedule a few days later based, at least in part, on events that occur during those few days); integrating to-do lists with reminders; integrating larger time-management systems with manual and automated analyses of required time and scheduling services; linking to automated and/or manual delegation; and integrating real-time composition tools having an ability to deliver task-oriented goals based on time required (e.g., to help users avoid overpromising based on other constraints on the user's time). Inferences may be personalized to individual users or user cohorts based on historical data, for example.

In other examples, task-oriented processes may involve: determining a “best” time to engage a user about confirming a request or commitment; identifying an “ideal” meeting time and/or location for a meeting action; identifying an “ideal” time for a reminder or other action; identifying how much time is needed to be blocked out for an event, meeting, etc.; determining when to take automated actions versus engaging users for confirmation or other user inquiries; integrating processes with a location prediction service or other resources for coordinating meeting locations and other aspects for task completion; tracking multiple task steps over time (e.g., steps involving commitments lofted or accepted, connections to a more holistic notion of the life history of a task, linking recognition of a commitment to the end-to-end handling of the task, including time allocation and tracking, etc.).

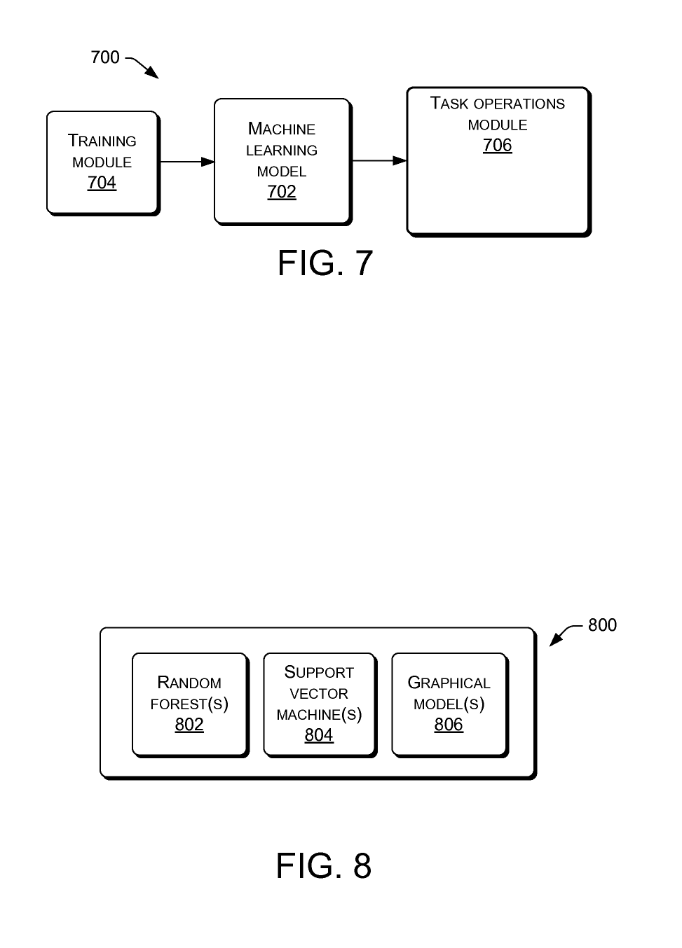

FIG. 7 is a block diagram of a machine learning system 700, according to various examples. Machine learning system 700 includes a machine learning model 702 (which may be similar to or the same as machine learning module 114, illustrated in FIG. 1), a training module 704, and a task operations module 706, which may be the same as or similar to task operations module 302, for example. Although illustrated as separate blocks, in some examples task operations module 706 may include machine learning model 702. Machine learning model 702 may receive training data from offline training module 704. For example, training data may include data from memory of a computing system that includes machine learning system 700 or from any combination of entities 302-324, illustrated in FIG. 3.

Telemetry data collected by fielding a commitment or request service (e.g., via Cortana® or other application) may be used to generate training data for many task-oriented actions. Relatively focused, small-scale deployments, e.g., longitudinally within a workgroup as a plugin to existing services such as Outlook® may yield sufficient training data to learn models capable of accurate inferences. In-situ surveys may collect data to complement behavioral logs, for example. User responses to inferences generated by a task operations module, for example, may help train a system over time.

Memory may store a history of requests and commitments received by and/or transmitted to the computing system or a particular user. Data from the memory or the entities may be used to train machine learning model 702. Subsequent to such training, machine learning model 702 may be employed by task operations module 706. Thus, for example, training using data from a history of requests and/or commitments for offline training may act as initial conditions for the machine learning model. Other techniques for training, such as those involving featurization, described below, may be used.

FIG. 8 is a block diagram of a machine learning model 800, according to various examples. Machine learning model 800 may be the same as or similar to machine learning model 702 shown in FIG. 7. Machine learning model 800 includes any of a number of functional blocks, such as random forest block 802, support vector machine block 804, and graphical models block 806. Random forest block 802 may include an ensemble learning method for classification that operates by constructing decision trees at training time. Random forest block 802 may output the class that is the mode of the classes output by individual trees, for example. Random forest block 802 may function as a framework including several interchangeable parts that can be mixed and matched to create a large number of particular models. Constructing a machine learning model in such a framework involves determining directions of decisions used in each node, determining types of predictors to use in each leaf, determining splitting objectives to optimize in each node, determining methods for injecting randomness into the trees, and so on.

Support vector machine block 804 classifies data for machine learning model 800. Support vector machine block 804 may function as a supervised learning model with associated learning algorithms that analyze data and recognize patterns, used for classification and regression analysis. For example, given a set of training data, each marked as belonging to one of two categories, a support vector machine training algorithm builds a machine learning model that assigns new training data into one category or the other.

Graphical models block 806 functions as a probabilistic model for which a graph denotes conditional dependence structures between random variables. Graphical models provide algorithms for discovering and analyzing structure in distributions and extract unstructured information. Applications of graphical models, which may be used to infer task content from non-text content, may include information extraction, speech recognition, image recognition, computer vision, and decoding of low-density parity-check codes, just to name a few examples.

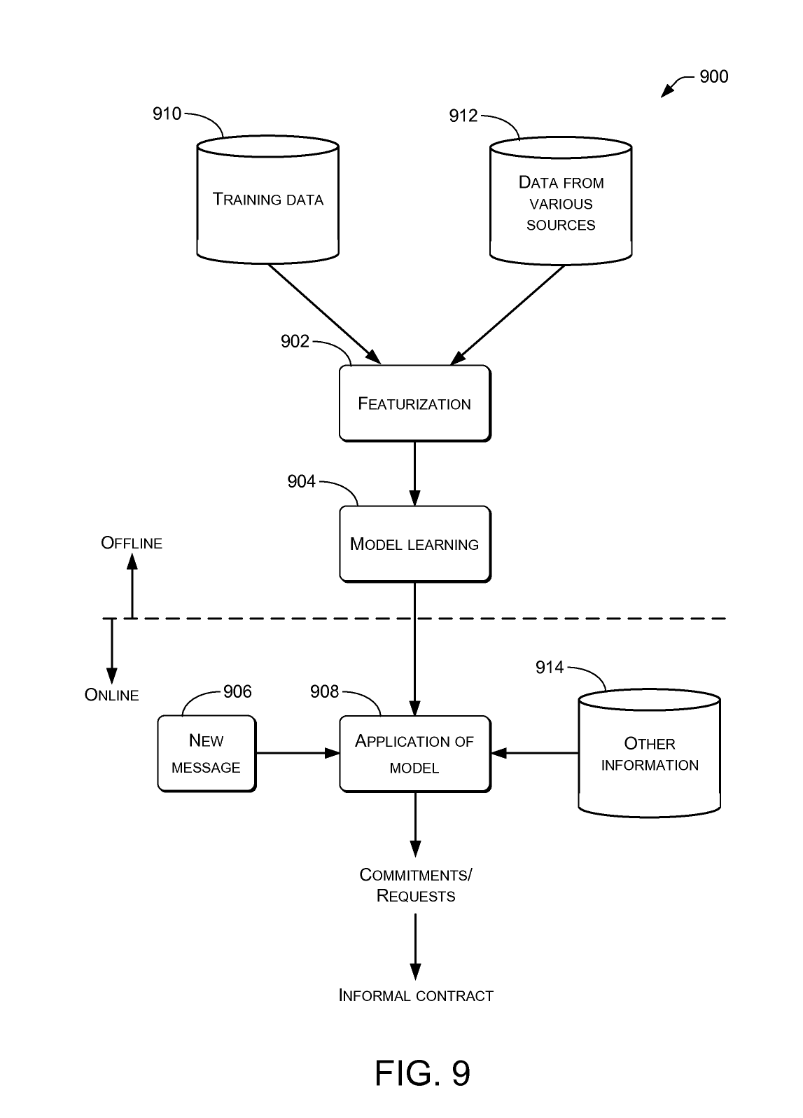

FIG. 9 is a block diagram illustrating example online and offline processes 900 involved in commitment and request detection and management. Such processes may be performed by a processor (e.g., a processing unit) executing module(s) (e.g., 114, and/or 116) or a computing device, such as computing device 102 described above. “Offline” refers to a training phase in which a machine learning algorithm is trained using supervised/labeled training data (e.g., a set of emails with commitment and request sentences labeled). “Online” refers to an application of models that have been trained to extract commitments and requests from new (unseen) emails. A featurization process 902 and a model learning process 904 may be performed by the computing device offline or online. On the other hand, receiving a new message 906 and the process 908 of applying the model may occur online.

In some examples, any or all of featurization process 902, model learning process 904, and the process 908 of applying the model may be performed by a task operations module, such as task operations module 116 or 302. In other examples, featurization process 902 and/or model learning process 904 may be performed in a machine learning module (e.g., machine learning module 114, illustrated in FIG. 1), and the process 908 of applying the model may be performed by a task operations module.

In some examples, featurization process 902 may receive training data 910 and data 912 from various sources, such as any of entities 304-324, illustrated in FIG. 3. Featurization process 902 may generate feature sets of text fragments that are capable of classification. Such a classification, for example, may be used in model learning process 904. Text fragments may comprise portions of content of one or more communications (e.g., generally a relatively large number of communications of training data 910). For example, text fragments may be words, terms, phrases, or combinations thereof. Model learning process 904 is a machine learning process that generates and iteratively improves a model used in process 908 for detecting and managing task content, such as requests and commitments (and thus one or more informal contracts), included in communications. For example, the model may be applied to a new message 906 (e.g., email, text, and so on). A computing device may perform model learning process 904 continuously, from time to time, or periodically, asynchronously from the process 908 of applying the model to new messages 906. Thus, for example, model learning process 904 may update or improve the model offline and independently from online process such as applying the model (or a current version of the model) to a message 906.

The process 908 of applying the model to new messages 906 may involve consideration of other information 914, which may be received from entities such as 304-324, described above. In some examples, at least a portion of data 912 from other sources may be the same as other information 914. The process 908 of applying the model may result in detection and management of task content included in new message 906. Such task content may include commitments and/or requests.

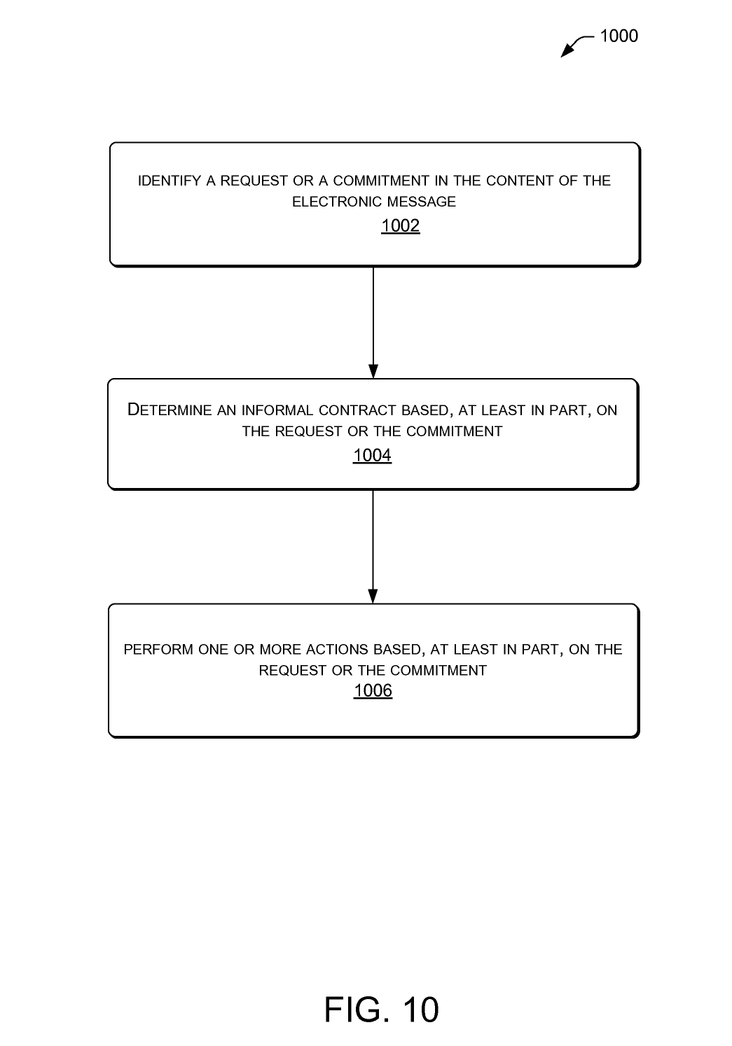

FIG. 10 is a flow diagram of an example task management process 1000 that may be performed by a task operations module or a processor (e.g., a processing unit) executing module(s). For example, process 1000 may be performed by computing device 102, illustrated in FIG. 1, or more specifically, in other examples, may be performed by task operations module 302, illustrated in FIG. 3.

At block 1002, the task operations module may identify a request or a commitment in the content of the electronic message. For example, an electronic message may comprise emails, text messages, non-text content, social media posts, and so on. Identifying a request or a commitment in the content of the electronic message may be based, at least in part, on one or more meanings of the content, for example. At block 1004, the task operations module may determine an informal contract based, at least in part, on the request or the commitment. In some examples, the task operations module may select one or more data sources further based, at least in part, on the request or the commitment. The data sources may include any of entities 304-324 described in the example of FIG. 3. The one or more data sources may be related to the electronic message by subject, authors of the electronic communications, persons related to the authors, time, dates, history of events, and organizations, just to name a few examples.

At block 1006, the task operations module may perform one or more actions based, at least in part, on the request or the commitment. The task operations module may perform such actions (e.g., task-oriented actions or processes) as blocking out time for an implied task, scheduling an appointment with others (e.g., the message sender or recipient, or a team or group), and reminding a user at a most-appropriate time about a request or commitment, just to name a few examples. In some examples, one or more actions of the task operations module may include determining appropriateness of responses to a request. For example, the response to a request from a working peer or assistant may be “No way, I'm just too busy right now.” The same request from a supervisor or manager, however, should likely not lead to such a response. Accordingly, the task operations module may include automatically determining appropriate responses based on the request and information regarding the request. Such appropriate responses may be provided to a receiver of the request as a list of selectable options. Subsequent to the receiver selecting one or more options, the task operations module may proceed to perform the one or more task-oriented actions.

In some examples, the electronic communications comprise audio, an image, or video. A conversion module may be used to convert the audio, the image, or the video to corresponding text so as to generate content of the electronic communications. The content of the electronic communications may be provided to the task operations module. In some examples, a task operations module may perform process 1000 in real time.

The flow of operations illustrated in FIG. 10 is illustrated as a collection of blocks and/or arrows representing sequences of operations that can be implemented in hardware, software, firmware, or a combination thereof. The order in which the blocks are described is not intended to be construed as a limitation, and any number of the described operations can be combined in any order to implement one or more methods, or alternate methods. Additionally, individual operations may be omitted from the flow of operations without departing from the spirit and scope of the subject matter described herein. In the context of software, the blocks represent computer-readable instructions that, when executed by one or more processors, configure the processor(s) to perform the recited operations. In the context of hardware, the blocks may represent one or more circuits (e.g., FPGAs, application specific integrated circuits—ASICs, etc.) configured to execute the recited operations.

Any routine descriptions, elements, or blocks in the flows of operations illustrated in FIG. 10 may represent modules, segments, or portions of code that include one or more executable instructions for implementing specific logical functions or elements in the routine.

### EXAMPLE CLAUSES

Example A, a system comprising:

A. A system comprising: a receiver port to receive content of an electronic message; and a processor to: identify a request or a commitment in the content of the electronic message; based, at least in part, on the request or the commitment, determine an informal contract; and execute one or more actions to manage the informal contract, the one or more actions based, at least in part, on the request or the commitment.

B. The system as paragraph A recites, wherein the processor is configured to: based, at least in part, on the request or the commitment, query one or more data sources; and in response to the query of the one or more data sources, receive information from the one or more data sources, wherein the one or more actions to manage the request or the commitment is further based, at least in part, on the information received from the one or more data sources.

C. The system as paragraph B recites, wherein the information of the one or more data sources comprises personal data of one or more authors of the content of the electronic message.

D. The system as paragraph B recites, wherein the one or more actions comprise determining likelihood that the commitment will be fulfilled by a particular person, wherein the determining is based, at least in part, on the information received from the one or more data sources.

E. The system as paragraph B recites, wherein a subject of the request or the commitment is associated with a meeting; and the one or more actions comprise: automatically identifying or modifying an attendee list or location for the meeting based, at least in part, on the information received from the one or more data sources.

F. The system as paragraph E recites, wherein the one or more data sources include at least one of location or mapping services, personal data of one or more authors of the content of the electronic message, calendar services, or meeting room schedule services.

G. The system as paragraph A recites, wherein the one or more actions comprise: modifying an electronic calendar of one or more authors of the content of the electronic message, wherein the modifying is based, at least in part, on relative relationships between or among the one or more authors.

H. The system as paragraph B recites, wherein the processor is configured to select the one or more data sources by applying statistical models to the content of the electronic message.

I. The system as paragraph B recites, further comprising: a machine learning module configured to use the content of the electronic message and/or the information from the one or more data sources as training data.

J. A method comprising: identifying a request or a commitment in an electronic message; determining an informal contract based, at least in part, on the request or the commitment; and determining a task-oriented process based, at least in part, on the informal contract.

K. The method as paragraph J recites, further comprising: searching one or more sources of data for information related to the request or the commitment in the electronic message; and receiving the information related to the request or the commitment in the electronic message from the one or more sources of data, wherein determining the task-oriented process is further based, at least in part, on the information received from the one or more data sources.

L. The method as paragraph J recites, further comprising: determining the task-oriented process while at least a portion of the electronic message is being generated.

M. The method as paragraph K recites, wherein the information related to the electronic message comprises one or more aspects of an author of the electronic message.

N. The method as paragraph J recites, further comprising: tracking one or more activities associated with the request or the commitment; and modifying the task-oriented process in response to the one or more activities.

O. The method as paragraph J recites, further comprising: grouping the request or the commitment with additional requests or commitments to form a project.

P. The method as paragraph K recites, wherein the one or more sources of data comprise an electronic calendar for an author of the electronic message, and further comprising: while the author is generating at least a portion of the electronic message that includes a commitment, notifying the author about time constraints likely to affect the commitment.

Q. A computing device comprising: a transceiver port to receive and to transmit data; and a processor to: detect a request or a commitment included in an electronic message; transmit, via the transceiver port, a query to retrieve information from one or more entities, wherein the query is based, at least in part, on the request or the commitment; manage one or more tasks associated with the request or the commitment, wherein the one or more tasks are based, at least in part, on the retrieved information.

R. The computing device as paragraph Q recites, wherein the retrieved information comprises a weather forecast, and wherein the one or more tasks include modifying a schedule associated with the request or the commitment based, at least in part, on the weather forecast.

S. The computing device as paragraph Q recites, wherein the processor is configured to: provide the electronic message or the retrieved information as training data for a machine learning process; and apply the machine learning process to managing the one or more tasks.

T. The computing device as paragraph Q recites, wherein the one or more tasks comprise iteratively modifying a schedule for one or more authors of the electronic message over a period of time.

Although the techniques have been described in language specific to structural features and/or methodological acts, it is to be understood that the appended claims are not necessarily limited to the features or acts described. Rather, the features and acts are described as examples of such techniques.

Unless otherwise noted, all of the methods and processes described above may be embodied in whole or in part by software code modules executed by one or more general purpose computers or processors. The code modules may be stored in any type of computer-readable storage medium or other computer storage device. Some or all of the methods may alternatively be implemented in whole or in part by specialized computer hardware, such as FPGAs, ASICs, etc.

Conditional language such as, among others, “can,” “could,” “might” or “may,” unless specifically stated otherwise, are used to indicate that certain examples include, while other examples do not include, the noted features, elements and/or steps. Thus, unless otherwise stated, such conditional language is not intended to imply that features, elements and/or steps are in any way required for one or more examples or that one or more examples necessarily include logic for deciding, with or without user input or prompting, whether these features, elements and/or steps are included or are to be performed in any particular example.

Conjunctive language such as the phrase “at least one of X, Y or Z,” unless specifically stated otherwise, is to be understood to present that an item, term, etc. may be either X, or Y, or Z, or a combination thereof.

Many variations and modifications may be made to the above-described examples, the elements of which are to be understood as being among other acceptable examples. All such modifications and variations are intended to be included herein within the scope of this disclosure.

What is claimed is:

1. A system comprising:
a receiver port to receive content of an electronic message; and
a processor to:
identify a request or a commitment in the content of the electronic message;
based, at least in part, on the request or the commitment, determine an informal contract; and
execute one or more actions to manage the informal contract, the one or more actions based, at least in part, on the request or the commitment.

2. The system of claim 1, wherein the processor is configured to:
based, at least in part, on the request or the commitment, query one or more data sources; and
in response to the query of the one or more data sources, receive information from the one or more data sources, wherein the one or more actions to manage the request or the commitment is further based, at least in part, on the information received from the one or more data sources.

3. The system of claim 2, wherein the information of the one or more data sources comprises personal data of one or more authors of the content of the electronic message.

4. The system of claim 2, wherein the one or more actions comprise determining likelihood that the commitment will be fulfilled by a particular person, wherein the determining is based, at least in part, on the information received from the one or more data sources.

5. The system of claim 2, wherein
a subject of the request or the commitment is associated with a meeting; and
the one or more actions comprise:
automatically identifying or modifying an attendee list or location for the meeting based, at least in part, on the information received from the one or more data sources.

6. The system of claim 5, wherein the one or more data sources include at least one of location or mapping services, personal data of one or more authors of the content of the electronic message, calendar services, or meeting room schedule services.

7. The system of claim 1, wherein the one or more actions comprise:
modifying an electronic calendar of one or more authors of the content of the electronic message, wherein the modifying is based, at least in part, on relative relationships between or among the one or more authors.

8. The system of claim 2, wherein the processor is configured to select the one or more data sources by applying statistical models to the content of the electronic message.

9. The system of claim 2, further comprising:
a machine learning module configured to use the content of the electronic message and/or the information from the one or more data sources as training data.

10. A method comprising:
identifying a request or a commitment in an electronic message;
determining an informal contract based, at least in part, on the request or the commitment; and
determining a task-oriented process based, at least in part, on the informal contract.

11. The method of claim 10, further comprising:
searching one or more sources of data for information related to the request or the commitment in the electronic message; and
receiving the information related to the request or the commitment in the electronic message from the one or more sources of data, wherein determining the task-oriented process is further based, at least in part, on the information received from the one or more data sources.

12. The method of claim 10, further comprising:
determining the task-oriented process while at least a portion of the electronic message is being generated.

13. The method of claim 11, wherein the information related to the electronic message comprises one or more aspects of an author of the electronic message.

14. The method of claim 10, further comprising:
tracking one or more activities associated with the request or the commitment; and
modifying the task-oriented process in response to the one or more activities.

15. The method of claim 10, further comprising:
grouping the request or the commitment with additional requests or commitments to form a project.

16. The method of claim 11, wherein the one or more sources of data comprise an electronic calendar for an author of the electronic message, and further comprising:
while the author is generating at least a portion of the electronic message that includes a commitment, notifying the author about time constraints likely to affect the commitment.

17. A computing device comprising:
a transceiver port to receive and to transmit data; and
a processor to:
detect a request or a commitment included in an electronic message;
transmit, via the transceiver port, a query to retrieve information from one or more entities, wherein the query is based, at least in part, on the request or the commitment;
manage one or more tasks associated with the request or the commitment, wherein the one or more tasks are based, at least in part, on the retrieved information.

18. The computing device of claim 17, wherein the retrieved information comprises a weather forecast, and wherein the one or more tasks include modifying a schedule associated with the request or the commitment based, at least in part, on the weather forecast.

19. The computing device of claim 17, wherein the processor is configured to:
provide the electronic message or the retrieved information as training data for a machine learning process; and
apply the machine learning process to managing the one or more tasks.

20. The computing device of claim 17, wherein the one or more tasks comprise iteratively modifying a schedule for one or more authors of the electronic message over a period of time.
